(19) United States
(12) Patent Application Publication
(10) Pub. No.: US 2001/0032121 A1
(43) Pub. Date: Oct. 18, 2001

(54) Method and apparatus for interactive focus marketing

(76) Inventor: Trien T. Le, Mequon, WI (US)

Correspondence Address: Jeffrey S. Gundersen, FOLEY & LARDNER, Firstar Center, 777 East Wisconsin Avenue, Milwaukee, WI, 53202-5367, US

(21) Appl. No.: 09/733,002

(22) Filed: Dec. 8, 2000

Related U.S. Application Data
(60) Provisional application No. 60/169,591, filed on Dec. 8, 1999.

(51) Int. Cl. G06F 17/60

(52) U.S. Cl. 705/14; 705/10

(57) ABSTRACT

An interactive focus marketing system is used to generate effective marketing packages for advertising in venues such as airports. A focus marketing data set is created from inputs such as demographic information and temporal information regarding the users of the venue. The interactive focus marketing system uses the internet to connect a main server to a number of local servers, kiosks, and client servers. The kiosks have a large display that displays an attract page. The kiosks further have a user input device such as a touch screen that may be used to interact with advertiser information.

This application claims the benefit of U.S. Provisional Application No. 60/169,591, filed Dec. 8, 1999.

### FIELD OF THE INVENTION

The present invention relates generally to the internet and advertising. More particularly, the present invention relates to a system configured to provide display advertising and interactive focus marketing using information from the internet.

### BACKGROUND OF THE INVENTION

The internet is rapidly becoming a significant medium through which individuals, businesses, and other entities can provide a wealth of information, such as information on goods and services, and transact sales of goods and services. The internet as an interactive medium permits an user to seek out desired information based on his or her navigation through the internet.

Presently, a prevailing method of advertising using the internet is through internet advertising banners (also referred to as “ad banners”). Based on the popularity and desired target audience of a web site, one or more businesses (i.e., advertisers) may purchase advertising time on that web site, in which an ad banner featuring the business' name, goods or services, or message is displayed on a portion of the web site or on a portion of a web page within the web site. In this manner, an advertiser hopes to raise brand awareness and/or interest the user into seeking more information about the advertiser such as by linking or “jumping” to the advertiser's own web site.

However, such advertising on the internet has a number of shortcomings. First, since web sites are confined to a browser environment, unless the user, or potential customer, is accessing the internet, ad banners would not even reach the user. In other words, the user must go to the ad banner, the ad banner cannot generally come to the user. Second, even if the user is accessing the internet, ad banners are only present in certain web sites. Thus, if the user is not accessing these specific web sites carrying ad banners, again the ad banners are ineffective. Third, because there are a great number of web sites available on the internet, any business having a web site would have to sufficiently promote its web presence (i.e., getting potential customers interested in and remembering its web address) before users would actively link to its web site. Hence, although the internet has desirable features such as flexibility, interactivity, timeliness, visual and/or audio content, ease in updating information, large amount of available information, and the ability to focus market (i.e., advertising with depth by permitting the user to immediately follow up on an advertisement to, for example, inquire about specific announcements or specials, or enter personal information), the internet is fairly ineffective as an advertising or promotional medium.

For this reason, businesses prefer passive visual and/or audio advertisements, through mediums such as periodicals, television, radio, and outdoor displays, to promote their goods and/or services. Passive advertisements are effective in reaching people, and in particular target audiences, because they are disseminated through mediums that most people come in contact with and/or utilize on a daily basis. Because passive advertisement mediums are readily accessible, passive advertisements have the advantage of coming to the potential customer instead of the potential customer having to go to the advertisements. Although passive advertisements are popular and common, they do have certain drawbacks. For example, display advertising, such as billboards, is typically disseminated to the general population and does not afford the capability of changing to fit the demographics of particular target viewers at a given time. Therefore, a purchase of display advertising can be inefficient because at certain times, only a small percentage of the viewers may be actually interested in the advertising message.

A further problem specific to display advertising is that in order to efficiently target display advertising, time and place specific demographic information would be required for the venue in question. This data is not currently available, especially for venues such as airports, convention centers, and train stations.

Additionally, with passive advertisements it is difficult to leave a lasting impression on the minds of the target audience such that potential customers would take immediate active action to follow-up on the promoted good or service. Passive advertisement, in of itself, does not provide any means for potential customers to immediately interact with the advertisement. Hence, traditional passive advertisements may be more effective than the internet in reaching target audiences and thereby increasing brand awareness, but it does little to provide focus marketing.

Thus, there is a need for a medium capable of effectively providing promotion of and interaction relating to a business' web site, goods and/or services. There is a further need for the medium to provide the easy accessibility and reaching features of passive-type advertisement along with the interactive and focus marketing features of the internet. There is still a further need for the medium to selectively utilize content available on the internet to provide the promotion and interaction capabilities. Further still, there is a need for an advertising medium for a particular venue, such as, an airport, that is targeted to a particular group of people, such as, passengers in a particular area at a particular time. Further still, there is a need for an advertising medium that may be quickly changed by an advertising client in response to market forces. Further still, there is a need for an advertising dataset that contains information regarding specific time and place demographics of a particular venue, such as an airport.

### SUMMARY OF THE INVENTION

One embodiment of the invention relates to a method of creating a focus marketing dataset including the steps of obtaining flight schedule information including flight times and gates, generating demographic information on a number of passengers of incoming and outgoing flights, generating temporal flow information on the passengers of the incoming and outgoing flights, and creating the focus marketing representative dataset of the demographic information of the passengers proximate a certain area of the airport at a certain time.

A further embodiment of the invention relates to a method of creating an airport advertising package. The method includes the steps of obtaining a focus marketing dataset specific to an airport, obtaining client marketing parameters, and comparing the client marketing parameters to the focus marketing dataset to determine times and locations that an advertisement should be displayed in the airport.

A still further embodiment of the invention relates to a method of advertising in an airport. The method includes the steps of providing an airport advertising package created using a focus marketing dataset, instructing a main server to enact the airport advertising package, communicating time and location instructions from the main server to at least one local server, communicating time and location instructions from the at least one local server to at least one kiosk having a large display, and displaying an attract page on the large display at the instructed times and locations.

A still further embodiment of the invention relates to a focus marketing dataset for an airport. The focus marketing dataset is made by the process of obtaining flight schedule information including flight times and gates, generating demographic information on a number of passengers of incoming and outgoing flights, generating temporal flow information on the passengers of the incoming and outgoing flights, and creating a dataset that indicates the demographic information of the passengers proximate a certain area of the airport at a certain time.

A still further embodiment of the invention relates to an airport advertising package. The airport advertising package is made by a process including the steps of obtaining a focus marketing dataset specific to an airport, obtaining client marketing parameters, and comparing the client marketing parameters to the focus marketing dataset to determine the times and locations an advertisement should be displayed in the airport.

A still further embodiment of the invention relates to a focus marketing dataset for an airport. The focus marketing dataset includes demographic information on airport visitors proximate a particular location, wherein the demographic information is a function of the time of day, wherein the dataset is in a format to be used by software operating on a computer.

A still further embodiment of the invention relates to an interactive focus marketing system. The system includes a main server, a communications network, a plurality of local servers connected to the main server via the communications network, and a plurality of kiosks connected to at least one of the local servers. The kiosks include a processor, a large display, an attract page displayed on the large display, and an operator console including an input device and an output device. Also included is a focus marketing dataset used to determine the optimal attract page.

A still further embodiment of the invention relates to a method of creating a focus marketing dataset for a venue including the steps of generating demographic information on a number of users of the venue, generating temporal flow information on the users of the venue, and creating a dataset that indicates the demographic information of the users proximate a certain area of the venue at a certain time.

A further embodiment of the invention relates to a method of creating a venue advertising package. The method includes the steps of obtaining a focus marketing dataset specific to the venue, obtaining client marketing parameters, and comparing the client marketing parameters to the focus marketing dataset to determine times and locations that an advertisement should be displayed.

A still further embodiment of the invention relates to a method of advertising in a venue. The method includes the steps of providing a venue advertising package created using a focus marketing dataset, instructing a main server to enact the venue advertising package, communicating time and location instructions from the main server to at least one local server, communicating time and location instructions from the at least one local server to at least one kiosk having a large display, and displaying an attract page on the large display at the instructed times and locations.

A still further embodiment of the invention relates to a focus marketing dataset for a venue. The focus marketing dataset is made by the process of generating demographic information on a number of users of the venue, generating temporal flow information on the users of the venue, and creating a dataset that indicates the demographic information of the passengers proximate a certain area at a certain time.

A still further embodiment of the invention relates to an venue advertising package. The venue advertising package is made by a process including the steps of obtaining a focus marketing dataset specific to a venue, obtaining client marketing parameters, and comparing the client marketing parameters to the focus marketing dataset to determine the times and locations an advertisement should be displayed.

A still further embodiment of the invention relates to a focus marketing dataset for a venue. The focus marketing dataset includes demographic information on venue users proximate a particular location, wherein the demographic information is a function of the time of day, wherein the dataset is in a format to be used by software operating on a computer.

### BRIEF DESCRIPTION OF THE DRAWINGS

The preferred embodiment will become more fully understood from the following detailed description, taken in conjunction with the accompanying drawings, wherein like reference numerals denote like elements, in which:

FIG. 1 is a block diagram of an internet and an interactive focus marketing system;

FIG. 2 is a block diagram of a kiosk which comprises a part of the interactive focus marketing system of FIG. 1;

FIG. 3 is a block diagram of a portion of the content accessed within the interactive focus marketing system of FIG. 1;

FIG. 4 is a flow chart of an enterprise scheduling method comprising a part of the interactive focus marketing system of FIG. 1;

FIG. 5 is a flow chart of content to be displayed on a display which comprises a part of the kiosk of FIG. 2;

FIG. 6 is a flow chart of an interaction method comprising a part of the interactive focus marketing system of FIG. 1;

FIG. 7 is a home page displayed on a touch screen which comprises a part of the kiosk of FIG. 2;

FIG. 8 is a weather page displayed on the touch screen which comprises a part of the kiosk of FIG. 2;

FIG. 9 is a client's web page displayed on the touch screen which comprises a part of the kiosk of FIG. 2; and

FIG. 10 is a block diagram of flow tracking software inputs and outputs comprising a part of the interactive focus marketing system of FIG. 1.

FIG. 11 is a perspective view of an embodiment of the kiosk.

### DETAILED DESCRIPTION OF THE INVENTION

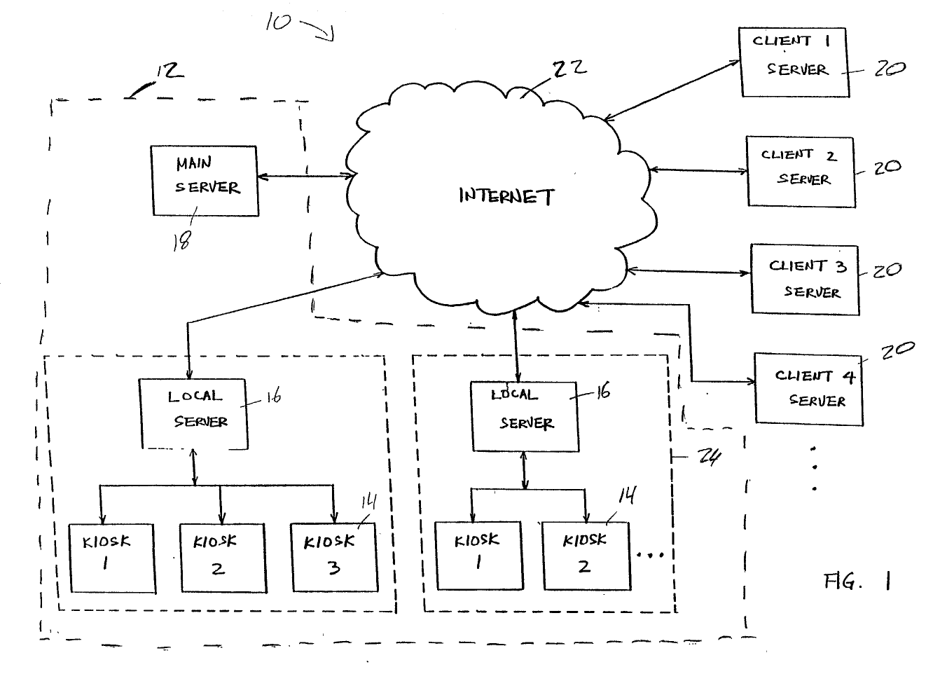

Referring to FIG. 1, hardware associated with an interactive focus marketing system 10 is shown in the block diagram. The system 10 includes a web server network 12. The web server network 12 is comprised of a number of venue servers, shown as local servers 16. Also included in the web server network 12 are a main server 18 and a number of kiosks 14. System 10 also includes any number of client servers 20. Web server network 12 can be connected to the client servers 20 via an internet 22. Internet 22 can be the connection medium for the main server 18, local servers 16, and client servers 20. Kiosks 14 do not communicate directly with the internet 22, but rather first interface with the associated local server 16, which can act as a proxy server in communicating with internet 22.

Kiosks 14 are connected to local servers 16 in a local network 24. The setup of local network 24 can be a conventional TCP/IP network or may utilize any of a variety of other communications protocols. Local network 24 can be an Ethernet, fiber optic, or wireless network.

Local servers 16 communicate with main server 18 via internet 22. Main server 18 controls the web server network 12, including all of the local servers 16 and kiosks 14 (by way of the local servers 16).

The web server network 12 interacts with the client servers 20 via the internet 22. Thus, the web server network 12 and the client servers 20 function as an extranet, as the web server network 12 will control access to the client servers 20. System 10 is exemplary and other system configurations may be used.

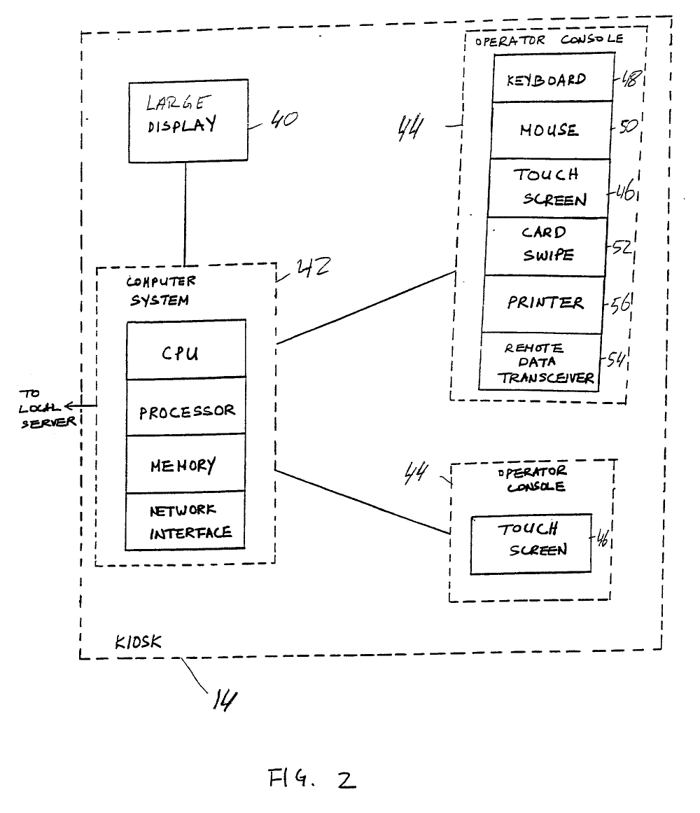

Referring now to FIG. 2, information (of various types, e.g., text, graphical, audio, and/or video) can be displayed on a large display device 40. The display device 40 is preferably any one of a large screen electronic display, such as, a large screen liquid crystal display (LCD), a light emitting diode (LED) display, a cathode ray tube (CRT) display, a projection display, etc., configured to provide information to a user. Preferably the display device 40 has a screen size of 42 inches or larger. The kiosk 14 directs the information to be displayed on the large display 40.

The kiosk 14 has a computer 42, and an operator console 44 that includes a number of input and output devices. Computer 42 may be a standard personal computer (PC) with touch screen capability and a network interface. The input devices on the operator console 44 can include but are not limited to such devices as a touch screen 46, a keyboard 48, a mouse 50, a card swipe 52, and a remote data transceiver 54. Output devices can include but are not limited to a printer 56 and the transceiver 54.

The transceiver 54 can communicate with a wireless communication device, such as an infrared or radio frequency device. Examples of these devices include but are not limited to personal digital assistants (PDAs), hand-held computers, or wireless computers. These devices typically have their own receiver and transmitter. For example, a user could use a PDA to download information from the kiosk 14, or to share information about the user with the kiosk 14. In one embodiment, when a user with a wireless communication device such as a PDA is proximal to a kiosk 14, within the defined operating range of the PDA, the kiosk 14 can beam information to the PDA, resulting in the PDA asking the user if he wishes to receive information from the kiosk 14, such as promotional literature.

The kiosk 14 may be a stand-alone information gathering and display device similar in size and network configuration to an ATM. The number of kiosks 14 at a particular venue is flexible depending on the needs of the users.

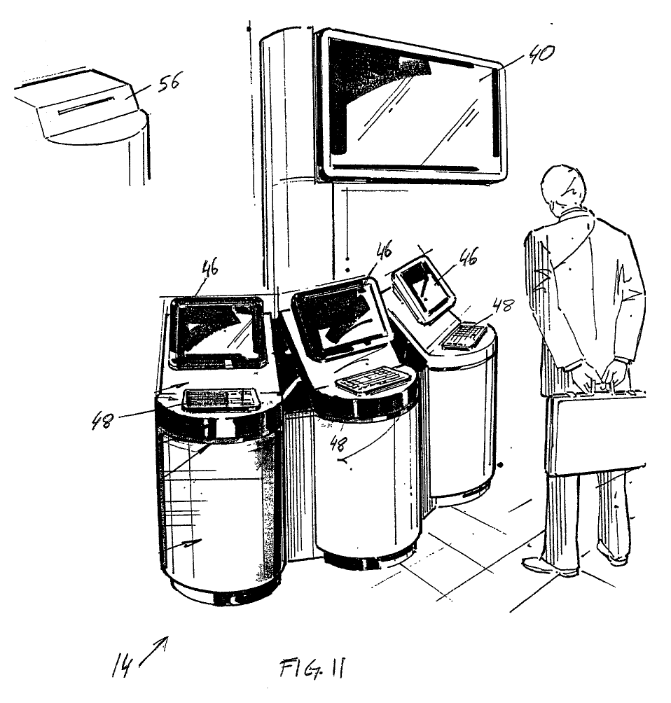

FIG. 11 depicts an exemplary environment of the kiosk 14. A user is shown standing proximal to the kiosk 14 with three touch screens 46, the large display 40, three keyboards 48, and a printer 56.

Using the above-described web server network 12 in conjunction with the internet 22 and client servers 20, information flows in the following fashion in the interactive focus marketing system 10. The main server 18 is programmed to control the overall flow of information. The main server 18 sends instructions to the local servers 16. Per these instructions, the local server 16 gathers information to be displayed on the large display 40 or kiosk 14 displays. In a preferred embodiment, the local server 16 gathers this information from client servers 20 via the internet 22. In addition to instructing the local server 16 as to which client servers 20 to visit to gather information, the main server 18 may also provide display information directly to the local server 16.

Computer 42 of kiosk 14 receives instructions from the local server 16 as to what information it should display. Thus, when the kiosk 14 displays information, for example, on the large display 40 or the touch screen 46, that information can come from the memory of computer 42 local server 16, main server 18, or any client server 20 that is connected to the internet 22, as directed by instructions from the main server 18 through the local server 16.

In an exemplary embodiment, the setup of the web server network 12 is such that information may be stored locally at the kiosk 14 level, or the local server 16 level. This setup permits information to be accessed and displayed more quickly than if the kiosk 14 always has to access other servers via the internet 22 in order to gather the information to be displayed.

As discussed above, the kiosk 14 accepts inputs from users through the operator console 44. In an exemplary embodiment, the user input is accepted via the touch screen 46. Information is displayed on the touch screen 46 in accordance with user inputs to touch screen 46. The information to be displayed can be client websites accessed via the internet 22. The extent of access by users to information via the operator console 44 is controlled by the main server 18 by way of the local server 16. As discussed above, the operator console 44 has a variety of other input and output devices that may be used in a conventional fashion.

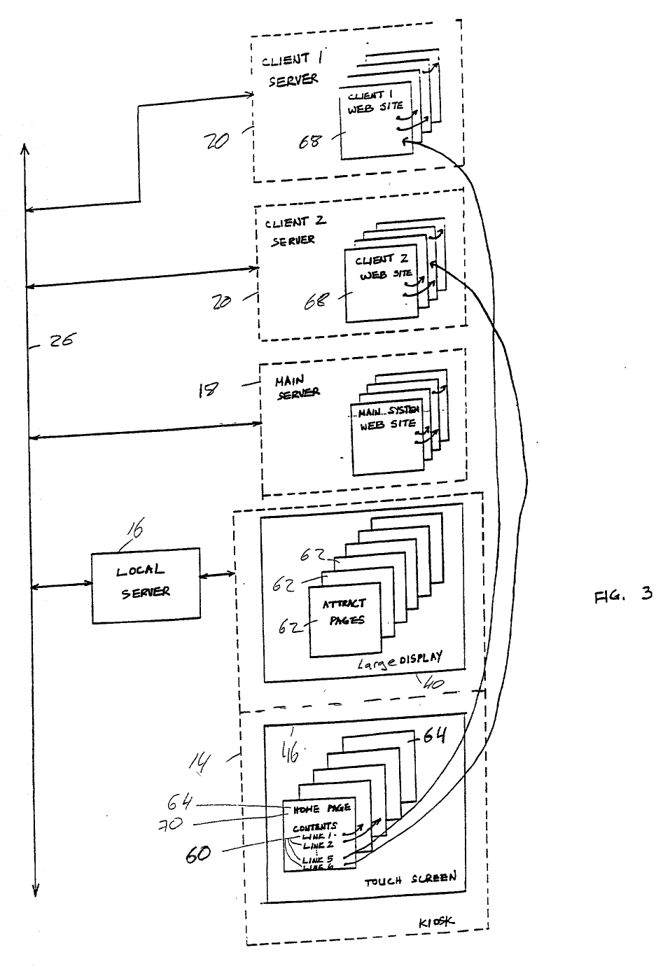

FIG. 3 illustrates a typical information flow associated with system 10. The large display 40 displays information, shown as attract pages 62, that can be viewed by potential users over a substantial distance because of the large screen of the display 40. Preferably, the large display 40 will attract users to the kiosk 14 for further interaction. The touch screen 46 can display information, shown as interaction pages 64, that have a number of links 60, one of which will likely correspond to the information displayed on the large display 40. The default interaction page 64 can be a home page 70. The user may then decide to garner more information by selecting one of the links 60 on the touch screen 46. As shown by the arrows on FIG. 3, the selective links can lead to other interaction pages 64 stored at the kiosk 14 level or to web pages 68 on client servers 20 via the extranet 26. Thus users can interact with external websites 68 to the extent permitted by the extranet 26.

Further referring to FIG. 3, clients are able to access the main server 18 to the extent permitted by the extranet 26 in order to conduct business. For example, clients could request that the links displayed on the touch screen 46 be changed to access different information, such as a different web page 68, on the client servers 20. Because the main server 18 controls all information displayed and acquired by the kiosks 14 via the local server 16, clients may efficiently tailor their information acquisition and display needs.

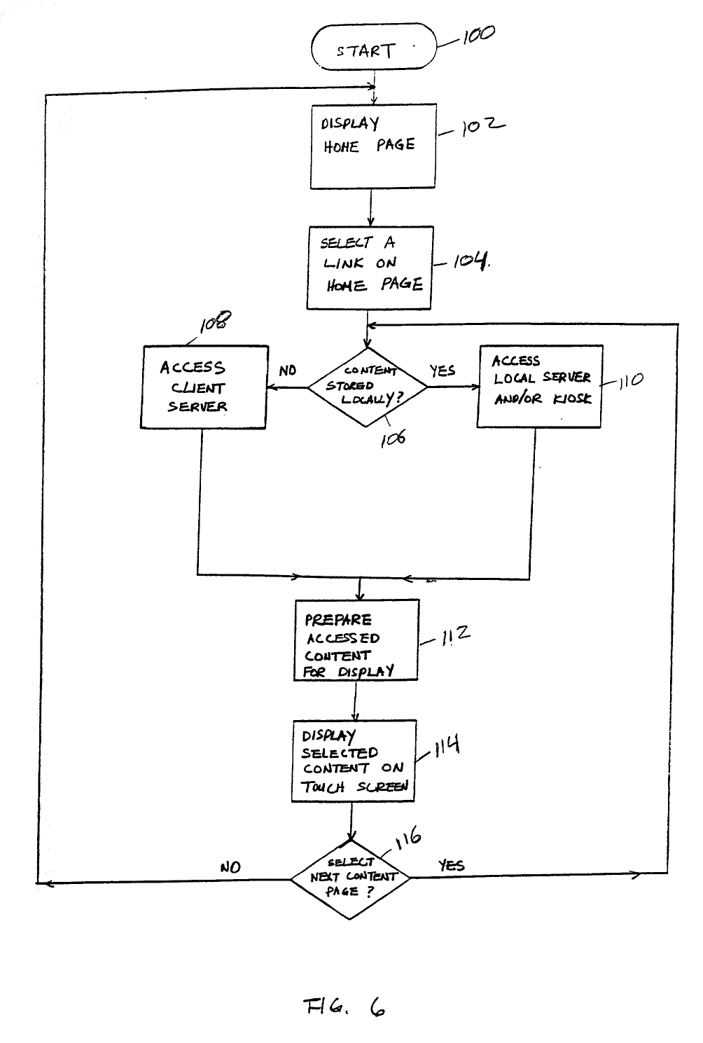

FIG. 6 displays a typical sequence of events with respect to user interactions at the kiosk 14 level. Before the kiosk 14 can perform any interaction, it must receive instructions from the local server 16 as to what information to display or acquire (step 100). The kiosk touch screen 46 then may show an interaction page 64 (step 102) such as the home page 70. A user may select a link 60 on the home page (step 104). If the requested information content is stored locally, the kiosk 14 will either access its own computer system 42 or the local server 16 to display that information (step 110). If the content is not stored locally, the kiosk will access a client server 20 via the internet 22 as limited by the extranet 26 (step 108). The kiosk 14 then prepares the accessed content for display, and displays that information on the touch screen 46 (step 114). At step 116, the user may decide to select a new interaction page 64. If the user does so, a determination as to whether the content of the newly selected page is stored locally or remotely is made (step 106). If the user does not select a next interaction page 64, the home page 70 is again displayed (step 102).

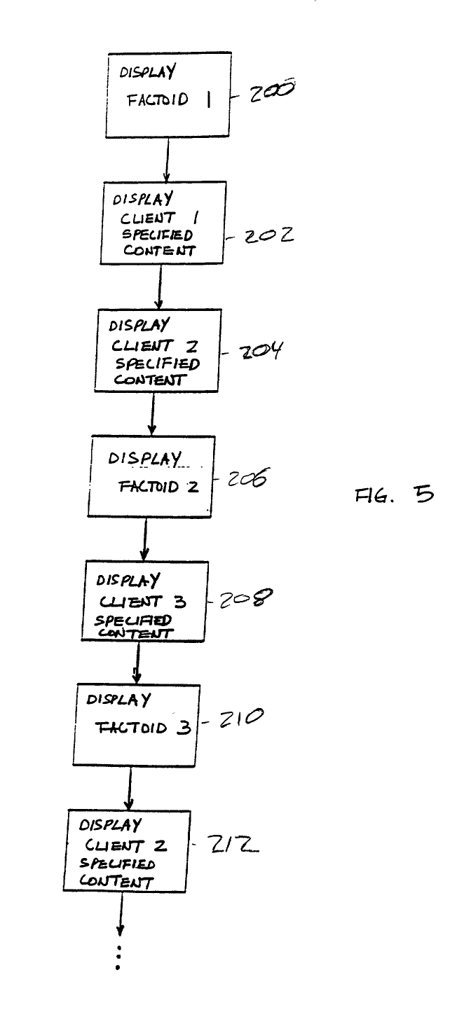

FIG. 5 displays the sequence of information displayed on the large display 40 to attract users of kiosk 14 in a exemplary embodiment. As directed by the main server 18 by way of the local server 16, the large display 40 will sequence through information such as displaying factoids as shown at steps 200, 206, and 210, or displaying client specified content as shown at steps 202, 204, 208, and 212.

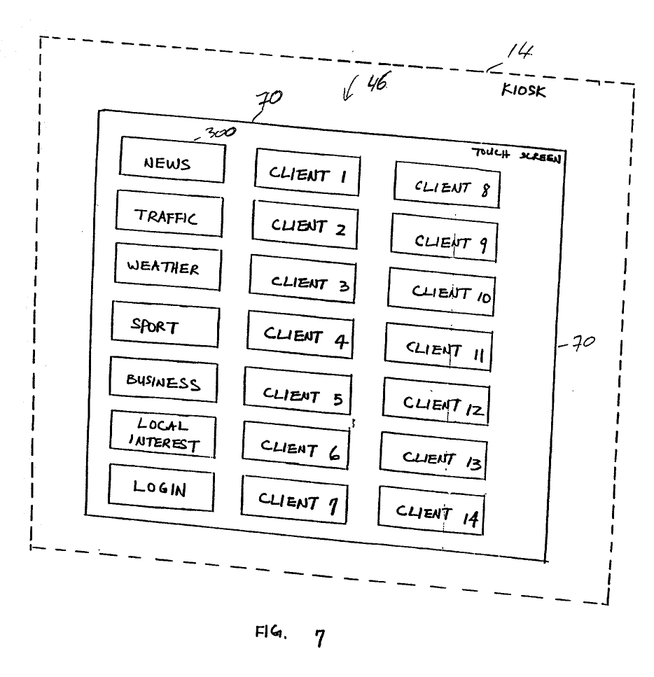

FIG. 7 shows an exemplary touch screen 46 layout when the home page 70 is being displayed, as indicated at step 102 on FIG. 6. A number of icons 300 can be displayed on the touch screen 46 to receive tactile input from the user. The icons 300 can correspond to clients or general purpose information. Preferably, the client icons 300 correspond to client information also being displayed on the large display 40.

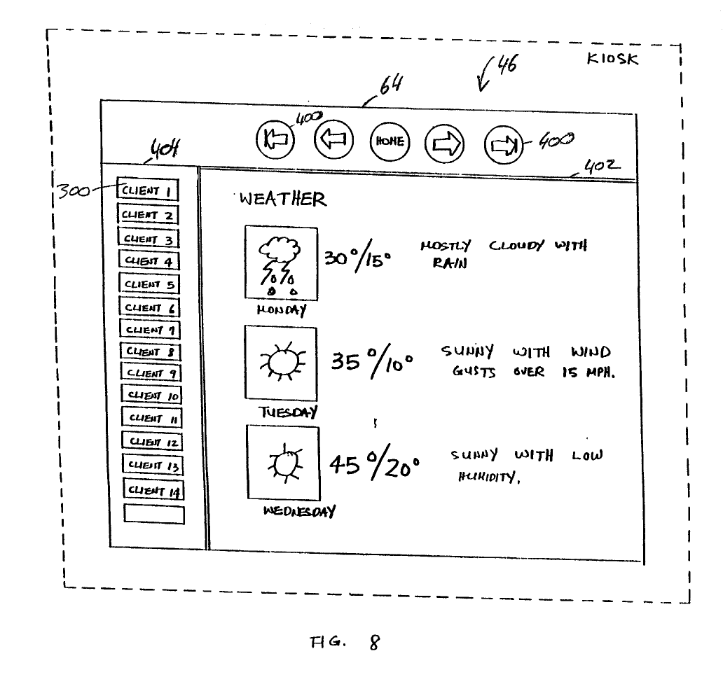

FIG. 8 shows an exemplary embodiment of the touch screen 46 after a user selects an icon 300. The requested information 402 can be displayed on the screen along with additional user input controls 400. The controls 400 will allow the user to select further information to be displayed, or return to the kiosk home page 70. Another area of the display 46 can show the icons 300 that were previously displayed on the home page 70, and can therefore be selected by the user for making an immediate jump to more client-specific interaction page 64.

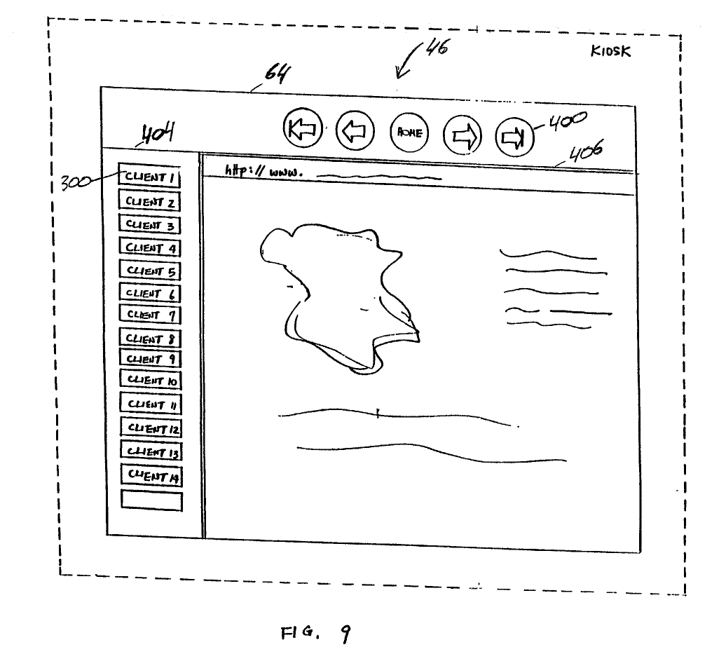

FIG. 9 depicts the information that can be displayed on the touch screen 46 when a user selects one of the client icons 300. Client-specific information can be displayed on a portion of the interaction page 64, while the user controls 400 and additional icons 300 are also displayed.

In a preferred embodiment, the interactive focus marketing system 10 is used for advertising purposes. The kiosks 14 are installed in locations where people can view the large display 40 and subsequently interact with the operator console 44. Advertisers can purchase time for their advertisements to be displayed on the large display 40 and as icons 300 on the kiosk touch screen 46. The interactive focus marketing system 10 uses temporal and demographic information to aid advertisers in deciding when, where, and what kind of advertisements to purchase for maximized target exposure.

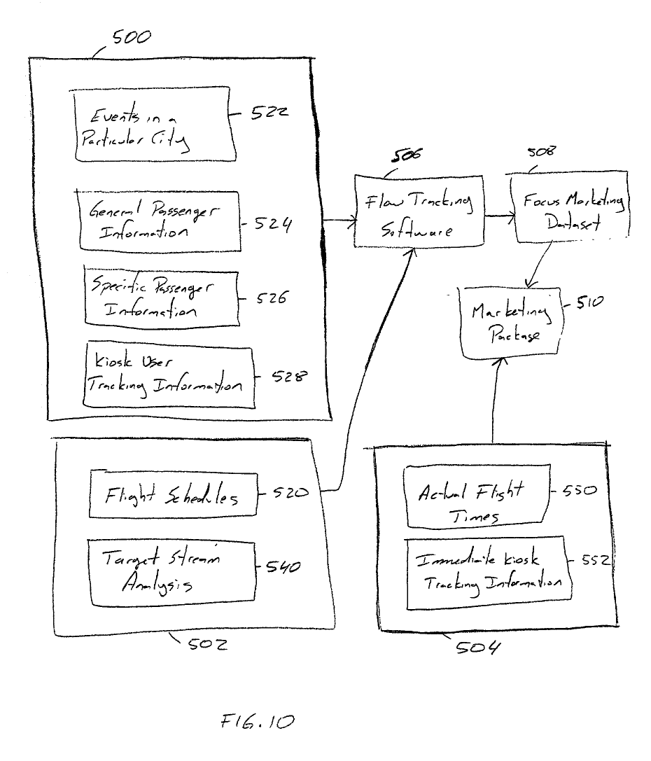

FIG. 10 shows how the interactive focus marketing system 10 gathers demographic and temporal information to help advertisers target their advertising message in the preferred embodiment. FIG. 10 relates to use of the system 10 in an airport. Flow tracking software 506 is used to compile demographic information 500, temporal information 502, and real time feedback information 504 to create effective marketing packages 510.

Exemplary types of demographic information 500 for an airport system can include such things as events in that particular city 522, general passenger information 524, specific passenger information 526, and prior kiosk user tracking results 528.

Another type of information that the flow tracking software 506 can use to construct marketing packages is temporal flow information 502. This information can include such things as flight schedules 520 and target stream analysis 540 within a particular venue such as, an airport.

Flight schedules 520 can be used to insure that large display 40 displays attract pages 62 targeted to passengers likely to be arriving at or departing to particular flights. Therefore, kiosks 14 placed at a particular gate or terminal can display information targeted directly at travelers whose flight just landed, or travelers heading toward a particular gate to board an airplane that will be taking off in the near future.

Events in a particular city 522 can be such things as conventions, sporting events, and tourist attractions. The flow tracking software 506 can compare the flight schedules 520 to events 522 to identify the interests of travelers arriving or departing in particular terminals or gates at the airport.

Target stream analysis 540 involves an analysis of passenger flow rates and predicted destinations. For example, upon departing from an airplane, passengers will proceed into the gate at which the airplane landed, then through the terminal at which that gate is located, and then likely to the baggage claim area. The departing passengers may then proceed to a car rental counter, or to a taxi stand. Because the timing of this sequence of events can be known, a particular advertisement could be targeted to the departing passengers of a particular flight along the entire route of their travel by sequencing a large screen display 40 attract page 62 from the gate, into the terminal, into the baggage claim area, and then out to the taxi stand or car rental counter. Likewise, outgoing passengers can be more effectively targeted by sequencing advertisements from kiosks 14 located in the check-in area, out to the airport common area, to the terminal, and then to the gate.

The flow tracking software 506 also takes into account general passenger information 524. General passenger information 524 can include such things as whether an arriving flight is merely taking passengers from a spoke city into a hub, or whether the passengers are traveling to that particular destination airport. For example, a Delta Airlines flight from a spoke city such as Louisville that is landing at Cincinnati, one of Delta's hub airports, is probably carrying primarily travelers from Louisville who are traveling through Cincinnati on to their final destinations. Accordingly, the attract page 62 could be directed to advertisements of interest to Louisville residents when that flight lands rather than relating to Cincinnati attractions, considering that the majority of those travelers will not be staying in Cincinnati.

Another example of general passenger information 524 can relate to the time and destination of a particular flight. For example, an 8:00 a.m. flight from Milwaukee to Washington D.C. is likely filled with business travelers. In contrast, an evening flight from that same gate on the same airline to Phoenix may be filled with vacationers and retirees. Accordingly, by combining the general passenger information 524 with flight schedules 520, the flow tracking software 506 can help advertisers specifically target their advertising message, rather than simply buying a display advertisement at a particular gate that all travelers regardless of demographics, will view.

A still further type of demographic information 500 is specific passenger information 526. Specific traveler information 526 can include data on the particular passengers traveling on an incoming or outgoing flight. An airline passenger list can be matched up with other computerized demographic databases to determine exact information regarding particular passengers on a flight. Thus, an advertiser can tailor its message to those passengers at the particular time that flight lands or is about to depart.

The flow tracking software 506 can also take into account kiosk tracking information 528. This tracking information 528 can include such things as whether passengers on particular flights are more or less likely to engage the kiosk 14 in response to a particular large screen display advertisement. All user interactions with the operator console 44 can be recorded and tracked.

The flow tracking software 506 takes the temporal flow information 502 and combines it with the demographic information 500 to create a focus marketing dataset 508. The focus marketing dataset 508 contains time and place specific demographic information. For example, the focus marketing dataset 508 can be used to detail the specific demographic information of the people within sight-distance of a certain kiosk large display 40 at a particular time and day. The focus marketing dataset 508 is used to tailor advertising packages such that advertisers need not purchase any more attract page 62 time than necessary to target the particular people they are aiming for.

Another type of information that can be used to tailor marketing packages 510 is real time feedback information 504. This type of information can include such things as actual flight times 550, as well as instantaneous kiosk tracking information 552. For example, an advertising package may have been purchased based on flight schedules 520 and demographic information 500 to target the people onboard an incoming flight from Boise. However, if that flight is delayed, the actual flight information 550 can be used to change the time at which the large screen display 40 displays the particular attract page 62 at the various kiosks 14 in the airport. Likewise, immediate kiosk tracking information 552 can be used by a client to tailor its advertising message based on real time information. Perhaps travelers are being attracted to the kiosk 14 by a client's attract page 62, but are primarily interested in accessing a particular web page on the client server 20 via the touch screen 46 that is not the one immediately linked to the client icon 300 (see FIG. 3). Accordingly, a client could immediately request through the extranet 26 that the linked web page 68 be changed to quickly optimize the advertising impact.

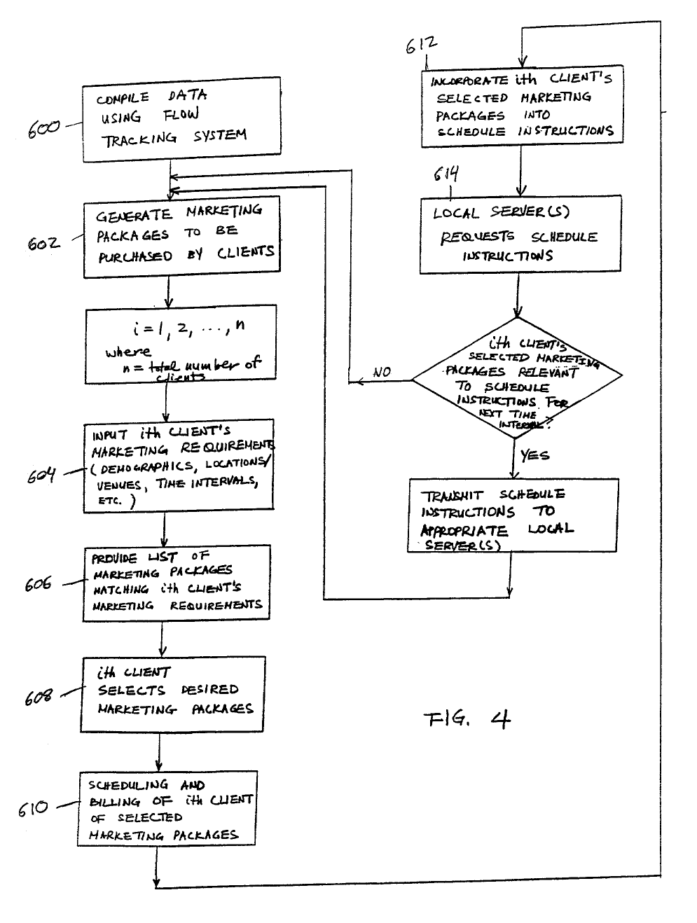

FIG. 4 demonstrates how the flow tracking software 506 generates marketing packages 510 and interacts with clients to generate advertising revenue. The flow tracking software 506 first compiles the relevant demographic information 500 and temporal information 502 into the focus marketing dataset 508 (step 600). The software then generates marketing packages 510 that may be purchased by clients who wish to target a particular demographic (step 602). A client can input its particular marketing requirements based on the products it wishes to sell (step 604). The interactive focus marketing system 10 then provides a list of marketing packages that match the requirements (step 606). The client can then select a marketing package (step 608), which is scheduled and the client is billed (step 610). The interactive focus marketing system 10 incorporates the selected marketing package into the schedule instructions sent from the main server 18 to the local server 16 and on to the kiosks 14 (step 612). Thus when a local server 16 requests schedule instructions at step 614, the main server 18 can insure that the selected marketing package is incorporated into large screen display 40 and kiosk touch screen 46 information.

Marketing packages 510 can be of several types. For example, a company can have a listing on the touch screen 46 in the form of a banner. Additionally, clients may chose to have a display on the large display 40. A client can design an interaction page 64 that is specific to the marketing package and can be stored at the local level, or use links to the client's web site 68. The marketing packages 510 include preferred times and locations corresponding to the desired demographic.

Another type of marketing package can include transmitting information directly to a user's PDA from the kiosk 14 using the transceiver 54. This type of information transfer is especially useful when a user does not have the time to extensively interact with the kiosk 14, or wishes to transmit electronic information, for example an electronic business card, directly to the kiosk.

The interactive focus marketing system 10 solves the problems with general internet sites and display advertising that were discussed in the Background section. The system 10 provides a way for web site owners to get customers to visit their site by combining immediate customer awareness outside the confined scope of the internet 22 by way of the large display 40 and permitting immediate accessibility to that client's web site and the possibility of purchase of that client's goods and/or services. Further, the system 10 provides an interactive advertising medium, in that customers can visit web pages 68 designated by the advertisers and provide or receive information. Further still, the system 10 allows advertisements to be directed at particular people or groups of people that are currently passing by the attract page 62. This targeting capability is made possible by the focus marketing dataset 508 used to create marketing packages 510. Thus, the system 10 minimizes inefficient purchase of display advertising time that would not be targeted at the desired target audience. Further still, the system 10 provides real time message modification capability in accordance with a client's needs.

While several embodiments of the invention have been described, it should be apparent to those skilled in the art that what has been described is considered at present to be the exemplary embodiments of an interactive focus marketing system. However, changes can be made in the design and method without departing from the scope of the invention. The following claims are intended to cover all such changes and modifications which fall within the scope of the invention.

What is claimed is:

1. A method of creating a focus marketing dataset for an airport, comprising the steps of:
obtaining flight schedule information including flight times and gates;
generating demographic information on a number of passengers of incoming and outgoing flights;
generating temporal flow information on the passengers of the incoming and outgoing flights; and
creating the focus marketing representative dataset of the demographic information of the passengers proximate a certain area of the airport at a certain time.

2. The method of creating a focus marketing dataset for an airport of claim 1, wherein the creating step includes creating the focus marketing dataset by utilizing flow tracking software operating on a computer.

3. The method of creating a focus marketing dataset for an airport of claim 1, wherein the demographic information includes general passenger information.

4. The method of creating a focus marketing dataset for an airport of claim 1, wherein the demographic information includes specific passenger information.

5. The method of creating a focus marketing dataset for an airport of claim 1, wherein the demographic information includes prior kiosk user tracking information.

6. The method of creating a focus marketing dataset for an airport of claim 1, wherein the demographic information includes data on events occurring in a particular city.

7. The method of creating a focus marketing dataset for an airport of claim 6, wherein one of the events occurring in a particular city is a convention.

8. The method of creating a focus marketing dataset for an airport of claim 1, wherein the temporal flow information includes probable passenger travel rates and paths within the airport.

9. A method of creating an airport advertising package, comprising the steps of:
obtaining a focus marketing dataset specific to an airport;
obtaining client marketing parameters; and
comparing the client marketing parameters to the focus marketing dataset to determine times and locations that an advertisement should be displayed in the airport.

10. The method of creating an airport advertising package of claim 9, wherein the time and location instructions maximize the similarity between a set of client marketing parameters, passenger demographic information, and temporal flow information.

11. A method of advertising in an airport, comprising the steps of:
providing an airport advertising package created using a focus marketing dataset;
instructing a main server to enact the airport advertising package;
communicating time and location instructions from the main server to at least one local server;
communicating time and location instructions from the at least one local server to at least one kiosk having a large display; and
displaying an attract page on the large display at the instructed times and locations.

12. The method of advertising in an airport of claim 11, further comprising the step of:
providing a kiosk input device to allow a user to obtain more information about an advertiser.

13. The method of advertising in an airport of claim 12, further comprising:
obtaining information on real-time usage of the kiosk input device; and
modifying the airport advertising package based on the real-time usage.

14. The method of advertising in an airport of claim 12, wherein the kiosk input device is selected from the group consisting of a touch screen, a keyboard, a mouse, a card swipe, and a wireless communication device.

15. The method of advertising in an airport of claim 14, wherein the touch screen provides an interaction page.

16. The method of advertising in an airport of claim 15, further comprising:
displaying a second interaction page in accordance with user input.

17. The method of advertising in an airport of claim 16, wherein one of the interaction pages is provided by a client server via an internet.

18. The method of advertising in an airport of claim 17, wherein one of the interaction pages is a web page.

19. The method of advertising in an airport of claim 11, further comprising:
communicating the attract page from a client server to the local server via an internet.

20. The method of advertising in an airport of claim 11, further comprising:
communicating the attract page from a client server to the main server via an internet.

21. The method of advertising in an airport of claim 11, further comprising:
obtaining information on actual arrival and departure times of selected flights; and
modifying the time and location instructions based on the actual arrival and departure times.

22. The method of advertising in an airport of claim 11, wherein the time and location instructions maximize the similarity between a set of client marketing parameters, passenger demographic information, and temporal flow information.

23. The method of advertising in an airport of claim 22, wherein the demographic information includes general passenger information.

24. The method of advertising in an airport of claim 22, wherein the demographic information includes specific passenger information.

25. The method of advertising in an airport of claim 22, wherein the demographic information includes prior kiosk user tracking information.

26. The method of advertising in an airport of claim 22, wherein the demographic information includes data on events occurring in a particular city.

27. The method of advertising in an airport of claim 26, wherein one of the events occurring in a particular city is a convention.

28. The method of advertising in an airport of claim 22, wherein the temporal flow information includes probable passenger travel rates and paths within the airport.

29. A focus marketing dataset for an airport made by a process comprising the steps of:
obtaining flight schedule information including flight times and gates;
generating demographic information on a number of passengers of incoming and outgoing flights;
generating temporal flow information on the passengers of the incoming and outgoing flights; and
creating a dataset that indicates the demographic information of the passengers proximate a certain area of the airport at a certain time.

30. An airport advertising package made by the process comprising the steps of:
obtaining a focus marketing dataset specific to an airport;
obtaining client marketing parameters; and
comparing the client marketing parameters to the focus marketing dataset to determine the times and locations an advertisement should be displayed in the airport.

31. A focus marketing dataset for an airport, comprising:
demographic information on airport visitors proximate a particular location, wherein the demographic information is a function of the time of day; and
wherein the dataset is in a format to be used by software operating on a computer.

32. The focus marketing dataset for an airport of claim 31, wherein the demographic information is compiled by inputting passenger demographic information and temporal flow information into a computer program.

33. An interactive focus marketing system, comprising:
a main server;
a communications network;
a plurality of local servers connected to the main server via the communications network;
a plurality of kiosks connected to at least one of the local servers, the kiosks comprising:
a processor;
a large display;
an attract page displayed on the large display; and
an operator console including an input device and an output device; and
a focus marketing dataset used to determine the optimal attract page.

34. The interactive focus marketing system of claim 33, further comprising:
a client server connected to the main server via the communications network.

35. The interactive focus marketing system of claim 33, wherein the input device is selected from the group consisting of a touch screen, a keyboard, a mouse, a card swipe, and a wireless communication device.

36. The interactive focus marketing system of claim 33, wherein the output device is selected from the group consisting of a transmitter and a printer.

37. The interactive focus marketing system of claim 33, wherein a touch screen included in each of the kiosks displays an interaction page.

38. The interactive focus marketing system of claim 37, wherein the interaction page includes an icon corresponding to the attract page.

39. The interactive focus marketing system of claim 38, wherein the icon is linked to a second interaction page.

40. A method of creating a focus marketing dataset for a venue, comprising the steps of:
generating demographic information on a number of users of the venue;
generating temporal flow information on the users of the venue; and
creating a dataset that indicates the demographic information of the users proximate a certain area of the venue at a certain time.

41. The method of creating a focus marketing dataset for a venue of claim 40, wherein the dataset is created by flow tracking software operating on a computer.

42. The method of creating a focus marketing dataset for a venue of claim 40, wherein the demographic information includes general venue user information.

43. The method of creating a focus marketing dataset for a venue of claim 40, wherein the demographic information includes kiosk user tracking information.

44. The method of creating a focus marketing dataset for a venue of claim 40, wherein the venue is a convention center.

45. The method of creating a focus marketing dataset for a venue of claim 40, wherein the venue is a train station.

46. The method of creating a focus marketing dataset for a venue of claim 40, wherein the temporal flow information includes probable user travel rates and paths within the venue.

47. A method of creating a venue advertising package, comprising the steps of:
obtaining a focus marketing dataset specific to the venue;
obtaining client marketing parameters; and
comparing the client marketing parameters to the focus marketing dataset to determine the times and locations an advertisement should be displayed.

48. The method of creating a venue advertising package of claim 47, wherein the times and locations are determined in part by maximizing the similarity between the client marketing parameters with venue user demographic information.

49. A method of advertising in a venue, comprising the steps of:
providing a venue advertising package created using a focus marketing dataset;
instructing a main server to enact the advertising package;
communicating time and location instructions from the main server to at least one local server;
communicating time and location instructions from the at least one local server to at least one kiosk having a large display; and
displaying an attract page on the large display at the instructed times and locations.

50. The method of advertising in a venue of claim 49, further comprising the step of:
providing a kiosk input device to allow a user to obtain more information about an advertiser.

51. The method of advertising in a venue of claim 50, wherein the kiosk input device is selected from the group consisting of a touch screen, a keyboard, a mouse, a card swipe, and a wireless communication device.

52. The method of advertising in a venue of claim 51, wherein the touch screen has an interaction page.

53. The method of advertising in a venue of claim 52, further comprising:
displaying a second interaction page in accordance with user input.

54. The method of advertising in a venue of claim 53, wherein one of the interaction pages is provided by a client server via a communications network.

55. The method of advertising in a venue of claim 53, wherein one of the interaction pages is a web page.

56. The method of advertising in a venue of claim 50, further comprising:
obtaining information on the real-time usage of the kiosk input device; and
modifying the advertising package based on the real-time usage.

57. The method of advertising in a venue of claim 49, wherein the time and location instructions maximize the similarity between a set of client marketing parameters and time and place specific venue user demographic information.

58. The method of creating a focus marketing dataset for a venue of claim 57, wherein the demographic information includes general venue user information.

59. The method of creating a focus marketing dataset for a venue of claim 57, wherein the demographic information includes kiosk user tracking information.

60. The method of creating a focus marketing dataset for a venue of claim 57, wherein the time and place specific venue user information includes temporal flow information, wherein the temporal flow interaction includes probable user travel rates and paths within the venue.

61. The method of advertising in a venue of claim 49, further comprising:
communicating the attract page from a client server to the local server via a communications network.

62. The method of advertising in a venue of claim 49, further comprising:
communicating the attract page from a client server to the main server via a communications network.

63. The method of creating a focus marketing dataset for a venue of claim 49, wherein the venue is a convention center.

64. The method of creating a focus marketing dataset for a venue of claim 49, wherein the venue is a train station.

65. A focus marketing dataset for a venue made by a process comprising the steps of:
generating demographic information on a number of users of the venue;
generating temporal flow information on the users of the venue; and
creating a dataset that indicates the demographic information of the users proximate a certain area of the venue at a certain time.

66. A venue advertising package made by the process comprising the steps of:
obtaining a focus marketing dataset specific to the venue;
obtaining client marketing parameters; and
comparing the client marketing parameters to the focus marketing dataset to determine the times and locations an advertisement should be displayed.

67. A focus marketing dataset for a venue, comprising:
demographic information on venue users proximate a particular location, wherein the demographic information is a function of the time of day; and
wherein the dataset is in a format to be used by software operating on a computer.

68. The focus marketing dataset for a venue of claim 67, wherein the demographic information is compiled by inputting venue user demographic information and temporal flow information into a computer program.
